(19) United States
(12) Patent Application Publication
(10) Pub. No.: US 2004/0011158 A1
(43) Pub. Date: Jan. 22, 2004

(54) Device for the automatic adjustment of the tension of a control cable

(76) Inventors: Thomas Roepke, Ashausen (DE); Yongxing Wang, Neu Wulmstorf (DE)

Correspondence Address: KENYON & KENYON, ONE BROADWAY, NEW YORK, NY, 10004, US

(21) Appl. No.: 10/418,586

(22) Filed: Apr. 18, 2003

(30) Foreign Application Priority Data
Apr. 19, 2002 (DE) 102 17 471.7

(51) Int. Cl. G05G 1/00

(52) U.S. Cl. 74/577 M

(57) ABSTRACT

A device is for the automatic adjustment of the tension of a control cable of a vehicle parking brake. The device includes a swivelling lever mounted rotatably on the axis of an actuating lever of the vehicle parking brake, a locking disc which is provided with a circumferential toothing, is mounted rotatably on the swivelling lever and is fastened to the control cable, a spring element which is connected at one end to the locking disc and is fixed at the other end on the vehicle and is prestressed in the tensioning direction of the control cable, and a carry-along element which is held on the actuating lever and is arranged with a toothing which, after a swivelling backlash of the actuating lever, meshes with the circumferential toothing of the locking disc. In order, in a simple manner, to avoid as far as possible undesirable noises of the device when actuating the parking brake, the carry-along element may be held in an elastically moveable manner on the actuating lever.

### CROSS-REFERENCE TO RELATED APPLICATIONS

The present application claims priority to Application No. 102 17 471.7, filed in the Federal Republic of Germany on Apr. 19, 2002, which is expressly incorporated herein in its entirety by reference thereto.

### FIELD OF THE INVENTION

The present invention relates to a device for the automatic adjustment of the tension of a control cable of a vehicle parking brake.

### BACKGROUND INFORMATION

A device is described in German Published Patent Application No. 199 54 823, in which a parking brake is described which has a hand brake lever as actuating lever and an automatic control-cable adjusting device. The hand brake lever is connected to the control cable, to which the brake is operatively connected, via a swivelling lever of the adjusting device and a locking disc which is mounted rotatably on the swivelling lever. The swivelling lever is mounted rotatably on the same axis as the actuating lever. The latter also has a carry-along element which has a toothed segment which, when the actuating lever is swivelled, comes into engagement with a circumferential toothing of the locking disc and therefore provides the operative connection between the actuating lever and the control cable. The locking disc also has a spring element which is fixed on the vehicle on one side and on the other side is mounted on the axis of rotation of the locking disc in a manner such that it is prestressed in the tensioning direction of the control cable.

If the toothing of the carry-along element comes into contact with the circumferential toothing of the locking disc, it is possible that, for reasons concerned with manufacturing tolerances or as a consequence of the rotational position of the locking disc, which changes under continuous adjustment of the control cable, the tooth heads of the toothing of the carry-along element abut against the tooth heads of the circumferential toothing of the locking disc. In this tooth-on-tooth position, further swivelling of the actuating lever causes the carry-along element to be raised together with the locking disc, in which case the tooth-on-tooth position is released after a certain lift owing to the ever increasing tensile force in the traction cable. As a consequence of the release, the toothing of the carry-along element falls, adopting a tooth-on-gap position into the external toothing of the locking disc, which is expressed in an annoying rattling noise. Furthermore, the tooth-on-tooth position results in increased wear to the toothings. In order to prevent incorrect positions of this type, additional, complicated synchronization devices have been used.

It is an object of the present invention to provide a device to the effect that, in a simple manner, undesirable noises of the device during actuation of the parking brake may be avoided as far as possible.

### SUMMARY

The above and other beneficial objects of the present invention may be achieved by providing a device as described herein.

Owing to the elastic moveability of the carry-along element, in the case of a tooth-on-tooth position of the toothing of the carry-along element and of the circumferential toothing of the locking disc, the carry-along element is forced back by contact with the said locking disc during the swivelling movement of the actuating lever, resulting in a small change in angle between the locking disc and the carry-along element. This may have the consequence that the two toothings are released from the incorrect position and the toothing of the carry-along element engages in the circumferential toothing. Since during this only a small part of the lifting force, which results from the swivelling movement of the actuating lever, acts on the locking disc, the toothings slide relatively gently into one another, with the result that an annoying rattling noise may not occur. This may at the same time reduce the wear of the toothings and may bring about a secure locking between the toothings from the beginning of contact of the toothings and therefore a secure, slip-free connection of the actuating lever to the control cable of the brake. Owing to the possibility, obtained in accordance with an example embodiment of the present invention, of the carry-along element being able to execute deflecting movements should the tooth heads of the two toothings accidentally come into contact, in which it may be possible for the force vector arising in the contact point to tilt in another direction and for the teeth of the toothings to latch into one another with little force, annoying noises of the device during actuation of the parking brake may be avoided in a simple manner.

The present invention is explained in greater detail below with reference to two exemplary embodiments illustrated in the drawings.

### BRIEF DESCRIPTION OF THE DRAWINGS

FIG. 1 illustrates, in a side view, a device according to an example embodiment of the present invention on a section of an actuating lever of a parking brake with the actuating lever not swivelled.

FIG. 2 illustrates the device illustrated in FIG. 1 in a side view with the carry-along element and the locking disc in contact in a tooth-on-tooth position.

FIG. 3 illustrates the device illustrated in FIG. 1 in a side view in a swivelled tooth-on-gap position of the carry-along element.

FIG. 4 illustrates, in a side view, a carry-along element of a device according to an example embodiment of the present invention with the swivelling operated by compression spring.

### DETAILED DESCRIPTION

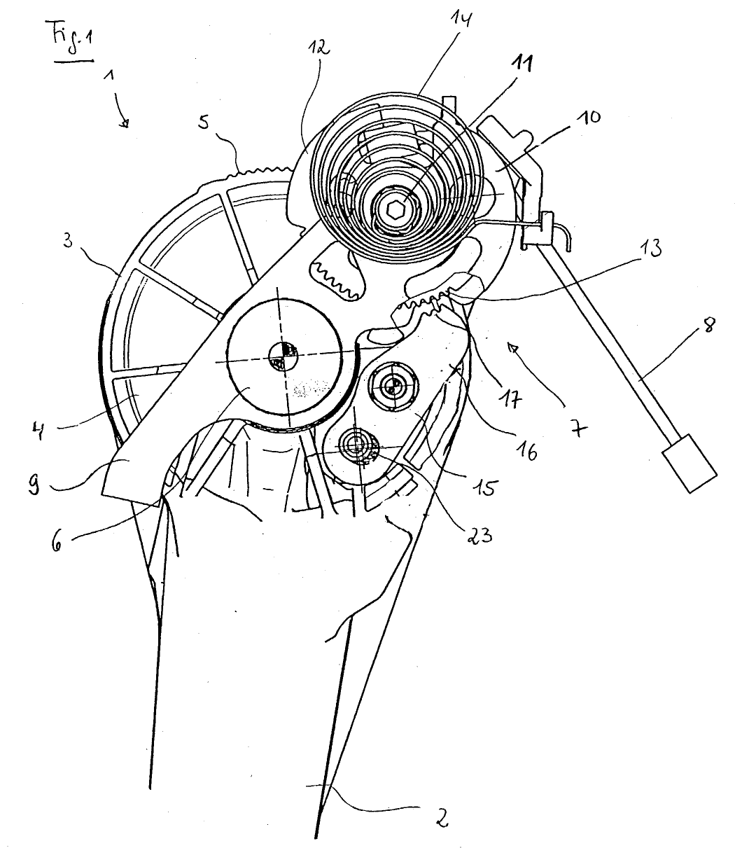

FIG. 1 illustrates a parking brake 1 in the form of a foot-operated parking brake of a motor vehicle, which has an actuating lever 2 arranged as a pedal. The device according to an example embodiment of the present invention is also possible for a hand brake. The toothed segment 5 is formed on the circumference 3 of the one end 4 of the actuating lever 2 and a spring element, which is fixed on the vehicle, grates along the said toothed segment in order to produce noise during actuation of the actuating lever 2. The locking of the actuating lever 2 in defined positions may be achieved by a friction-spring principle. The actuating lever 2 is mounted pivotably by its end 4, which may be arranged in the form of a circular disc, on an axis 6 fixed on the vehicle.

The actuating lever 2 is operatively connected to a device 7 for the automatic adjustment of the tension of a control cable 8 of the parking brake 1. The device 7 has a swivelling lever 9 which is mounted rotatably on the axis 6 of the actuating lever 2. Parallel to the axis 6, an axis of rotation 11, on which a locking disc 12 is mounted rotatably, is arranged at one end 10 of the swivelling lever 9. The locking disc 12 has a segmental circumferential toothing 13 in the lower circumferential region, with the control cable 8 being fastened at one end to the upper circumferential region. On the axis of rotation 11 penetrating the swivelling lever 9 a spring element, for example in the form of a spiral spring 14, is arranged on the opposite side of the locking disc 12, the spiral spring being fixed at one end on the axis of rotation 11 and therefore being connected to the locking disc 12 and at the other end being fixed on the vehicle. The spiral spring 14 is prestressed in the tensioning direction of the control cable 8 and, by its connection to the locking disc 12, compensates, owing to its prestress, for a wear-induced lengthening or, if it is very cold, a contraction of the control cable 8. The locking disc 12 rotates in the one or other direction depending on which state is present. Furthermore, a fishplate-like carry-along element 15 is fastened, e.g., riveted, to the end 4 of the actuating lever 2 and, at one end 16, bears a toothing 17 on the upper side in the form of a toothed segment (e.g., with three teeth). The carry-along element 15 is arranged in the same plane as the locking disc 12 and is arranged in the vicinity of its lower circumferential region.

If the actuating lever 2 is swivelled, normally, after a swivelling backlash, the toothing 17 of the carry-along element 15, which is swivelled at the same time, meshes with the circumferential toothing 13 of the locking disc 12, as a result of which locking takes place between the actuating lever 2 and the device 7 and hence the operative connection between the actuating lever 2 and the control cable 8 is produced. The device 7 is thereby raised together with the control cable 8 and the brake 1 is thus applied.

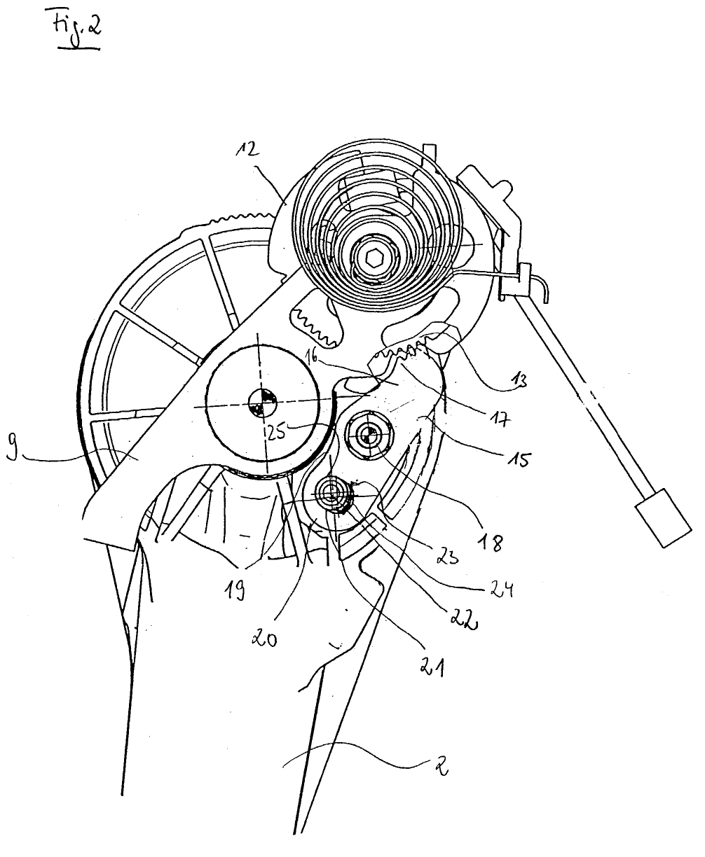

In order to avoid a non-meshing tooth-on-tooth position, as illustrated in FIG. 2, occurring now and then, the carry-along element 15 is held in an elastically moveable manner on the actuating lever 2. A number of structural forms for the carry-along element 15 are possible for this. For example, the carry-along element 15 may be held with sufficient play and supported resiliently in a guide arranged on the actuating lever, with the result that the swivelling movement of the actuating lever 2 and of the swivelling lever 9 in conjunction with the elastic pressing back of the carry-along element 15 causes a deflection of the carry-along element 15, the deflection being within the scope of the play and having the effect of changing the toothings 13 and 17 from the tooth-on-tooth position into the tooth-on-gap position.

In structurally more simple variants and with greater functional stability, the carry-along element 15 illustrated in FIGS. 1 to 4 is of fishplate-like arrangement and is mounted rotatably on an axis 18 arranged on the actuating lever 2, with the carry-along element 15 being supported elastically on the actuating lever 2. Thus, on contact with the locking disc 12, the carry-along element 15 is rotated back relative to the latter, as a result of which, in the entire movement of the lever system, in which the carry-along element 15 is not only swivelled by the swivelling movement of the actuating lever, but also undergoes a lift, a lateral offset occurs between the carry-along element 15 and the locking disc 12 in the plane in which the carry-along element 15 and the locking disc 12 are arranged. This leads to the toothings 17 and 13 engaging in one another. The resilient support means that after this relative rotational movement and release from the tooth-on-tooth position, the carry-along element 15 is pressed back again, so that a secure engagement of the toothings 13 and 17 may be ensured. One simple possible manner of providing the support may be for the carry-along element 15 to be supported on the actuating lever 2 at least on one longitudinal side 19 by a compression spring. In this case, it is possible structurally and with regard to using the largest possible lever arm if the compression spring engages on the end 20 arranged opposite the end 16 of the carry-along element.

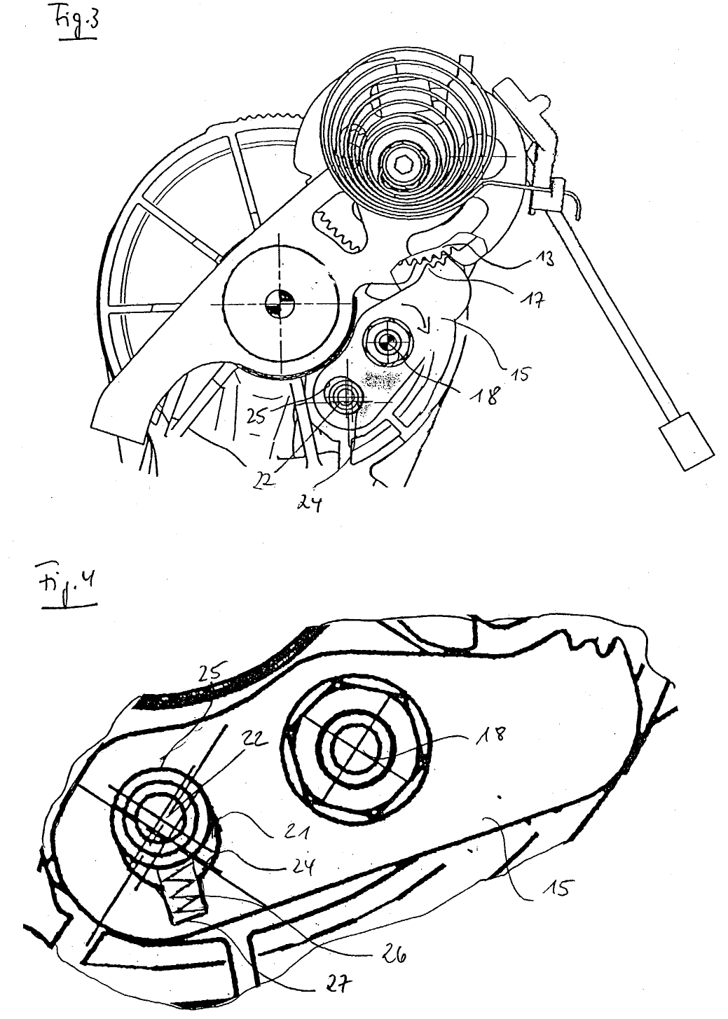

As an alternative to this, in a construction-space-saving version illustrated in FIGS. 2 and 3, a through-hole 21 in the form of a slot is formed in the carry-along element 15 and has a pin 22, bolt, etc. fastened to the actuating lever 2 protruding through it. The pin 22 is used firstly for limiting the swivelling angle of the carry-along element 15. Secondly, an elastically resilient supporting element, against which the pin 22 bears, is arranged in the through-hole 21. The supporting element is fastened here to that side 24 of the through-hole 21 which faces the toothing. If, as illustrated in FIG. 3, the carry-along element 15 is swivelled according to the direction of the arrow under the influence of the tooth-on-tooth position, the supporting element is compressed between the side 24 and the pin 22. After engagement of the toothings 13 and 17, the supporting element presses the side 24 of the through-hole 21 away from the pin 22 again, with the latter coming to rest on the opposite side 25 of the through-hole 21.

As in the exemplary embodiment illustrated in FIGS. 1 to 3, the supporting element may include an elastomer 23, for example, as a piece of tubing or as a body made from solid material which is bonded onto the side 24 of the through-hole 21. In an example embodiment illustrated in FIG. 4, the supporting element may also be a compression spring 26 which is embedded in a groove 27 formed on the side 24 of the through-hole 21. The compression spring may provide simplified replacement if impermissibly high wear occurs.

What is claimed is:

1. A device for automatic adjustment of tension of a control cable of a vehicle parking brake, comprising:
a swivelable lever mounted rotatably on an axis of an actuating lever of the vehicle parking brake;
a locking disc including a circumferential toothing mounted rotatably on the swivelable lever, the locking disc configured to fasten to the control cable;
a spring element connected at a first end to the locking disc and configured to be fixed to the vehicle at a second end, the spring element prestressed in a tension direction of the control cable; and
a carry-along element held elastically moveably on the actuating lever and including a toothing adapted to mesh with the circumferential toothing of the locking disc after a swivel backlash of the actuating lever.

2. The device according to claim 1, wherein the carry-along element includes a fishplate arrangement, is mounted rotatably on an axis arranged on the actuating lever and is supported elastically on the actuating lever.

3. The device according to claim 2, further comprising a compression spring configured to support the carry-along element on the actuating lever at least on one longitudinal side.

4. The device according to claim 2, wherein the carry-along element includes a through-hole, the device further comprising:
a pin fastened to the actuating lever and protruding through the through-hole; and
an elastically resilient supporting element fastened to a side of the through-hole facing the toothing, the pin arranged to bear against the supporting element.

5. The device according to claim 4, wherein the supporting element is formed of an elastomer.

6. The device according to claim 4, wherein the supporting element includes a compression spring.

7. A device for automatically adjusting tension of a control cable of a vehicle parking brake, comprising:
swivelling lever means mounted rotatably on an axis of an actuating lever of the vehicle parking brake;
locking means including a circumferential toothing mounted rotatably on the swivelling lever means, the locking means for fastening to the control cable;
spring means connected at a first end to the locking means and for fixing to the vehicle at a second end, the spring means prestressed in a tension direction of the control cable; and
carry-along means held elastically moveably on the actuating lever and including a toothing for meshing with the circumferential toothing of the locking means after a swivel backlash of the actuating lever.
